(19) United States
(12) Patent Application Publication
(10) Pub. No.: US 2016/0122501 A1
(43) Pub. Date: May 5, 2016

(54) RUBBER COMPOSITION COMPRISING EMULSION-POLYMERIZED CONJUGATED DIENE POLYMER AND SILICA SUSPENSION, AND METHOD FOR PRODUCING SAME

(71) Applicants: ETIC INC., Tokyo (JP); NIPPON A&L INC., Osaka (JP)

(72) Inventors: Iwakazu Hattori, Tokyo (JP); Hisao Ono, Tokyo (JP); Kimio Misaki, Niihama-shi, Ehime (JP); Hiroshi Miwata, Osaka-shi, Osaka (JP)

(73) Assignees: ETIC Inc., Tokyo (JP); NIPPON A&L INC., Osaka-shi, Osaka (JP)

(21) Appl. No.: 14/779,989

(22) PCT Filed: Mar. 20, 2014
(86) PCT No.: PCT/JP2014/057751

§ 371 Date: Jan. 15, 2016

(30) Foreign Application Priority Data
Mar. 25, 2013 (JP) 2013-062996

(51) Int. Cl. C08K 3/36; B60C 1/00

(52) U.S. Cl. CPC C08K 3/36; B60C 1/0016

(57) ABSTRACT

Provided are: a rubber composition (a silica master batch) that contains silica in a highly dispersed state, which is prepared by mixing a suspension with an emulsion of an emulsion-polymerized conjugated diene polymer and then coagulating the resultant mixture, wherein the suspension is prepared by highly dispersing wet silica, which does not undergo secondary coagulation yet, or silica, which is prepared by mechanically dissociating secondary coagulation masses of silica, in water and the emulsion-polymerized conjugated diene polymer contains a functional group that is reactive with silica or has high affinity for silica; and a method for producing the rubber composition. A clam (a small mass of a rubber) which contains silica in a highly dispersed state is hardly dried. Therefore, the clam is dried in an apparatus which is composed of a drying apparatus composed of a dehydrator and a hot-air drier and a heating roll for drying purposes provided to the drying apparatus, whereby a rubber composition in which silica is highly dispersed and which has high reinforcing performance can be produced. As a method for mixing the emulsion of the emulsion-polymerized conjugated diene copolymer with the silica suspension, a mere agitating/mixing procedure can be employed, and a process of mixing the components homogenously while applying a stimulus such as heat or pressure to the mixture of the components using a steam ejector to cause the coagulation of the components can also be employed desirably.

### TECHNICAL FIELD

The present invention relates to a rubber composition of silica master-batch, produced by mixing a silica aqueous solution or a silica suspension (may be simply referred to as a suspension) and an emulsion-polymerized conjugated diene copolymer in the state of latex which comprises a functional group having high affinity to silica, followed by coagulating and drying. In particular, the present invention relates to a master-batch consisting of a rubber component and silica, and to a rubber composition for tires comprising the master-batch.

Hereinafter, emulsion-polymerized styrene-butadiene rubber (E-SBR) itself, or E-SBR to which emulsion-polymerized diene copolymer comprising other monomers or monomers having functional groups are blended, may also be represented by E-SBR.

### BACKGROUND ART

Energy saving of automobiles has long been socially demanded, and automobiles are strictly required to correspond to low fuel consumption in recent years. With respect to tires of automobiles, etc., since around 1980s, from the viewpoint of improvement in low fuel consumption, extended interval of tire replacement due to improved abrasion resistance, and improvement in braking performance on wet road (hereinafter referred to as wet grip performance), polymer-end-modified solution-polymerized styrene-butadiene rubbers (S-SBRs) have been used in order to disperse carbon black with small particle size as a reinforcing agent, and studies for improvement are still continued.

In the early 1990s, silica-filled rubber tires were released from Michelin tire company, and merits of blending silica were recognized; at present, silica-filled rubber tires are considered essential for improving low fuel consumption and wet grip performance. However, silane coupling agent is necessary for 0 silica, which restricts the temperature condition of rubber kneading. In addition, when silica is filled in the rubber for tires, because silica is difficult to disperse compared to carbon black, a larger number of kneading steps is required, resulting in a cost increase.

At first, a silica-filled rubber composition was produced by kneading a polymer-end-modified solution-polymerized styrene-butadiene rubber (S-SBR) in which alkoxysilyl groups or amino groups having high reactivity to silica were introduced at its polymer end, using a Banbury mixer or roll mixer as in the case of blending carbon black. However, because kneading was difficult and dispersion of silica was not sufficient, a wet master-batch process was proposed, wherein rubber and silica were mixed in a solution state, coagulated and dried.

There has been an attempt that silica is mixed in an organic solvent with S-SBR having alkoxysilyl groups with high reactivity to silica at its polymer end; however, uniform dispersion of both components in the organic solvent in a stable manner was difficult, and complete removal of the organic solvent was difficult; accordingly, industrial production was not successful. (Patent Document 1)

As an improvement of dry master-batch process that does not use solution, there has been an attempt to use a silane coupling agent, etc. having high reactivity to silica in a rubber composition comprising both silica and carbon black; however, several problems must be solved for industrialization. (Patent Documents 2 and 3)

As an improved method using natural rubber latex, there is a preparation method of wet master-batch wherein a dispersion that is made by previously dispersing carbon black and silica in an aqueous solution is mixed and coagulated; however, several problems exist, including that a step to decompose amid bond in the natural rubber is necessary, that the natural rubber itself exhibits poor reinforcing effect by fillers, and that the natural rubber itself does not have functional groups having high reactivity to silica, and therefore effects to improve physical properties are low. (Patent Document 4)

There has been an attempt of silica master-batch produced by mixing E-SBR, undried silica, and a silane coupling agent in a state of aqueous solution, and by coagulating and drying; however, stable preparation is considered to be difficult due to the following reasons: coupling of three substances, i.e., silica, silane coupling agent and E-SBR, is indispensable for improving the performance of this method, but the silane coupling agent is used in the state of aqueous solution, and E-SBR itself does not have functional groups having high reactivity to silica. (Patent Document 5)

There is a disclosure of a silica-filled rubber compound, wherein a terpolymer that is copolymerized with monomers containing functional groups having high reactivity to silica is adopted as E-SBR. (Patent Documents 6 and 7)

However, in any of these methods, mixing is performed in a dried state and silica remains in its agglomerate state; therefore, dispersion of the silica is not sufficient.

There has been an attempt of a rubber composition and its production method, wherein three components, i.e., E-SBR latex, silica suspension, and cationic polymer, are coagulated. (Patent Document 7)

There has been an attempt of a rubber composition, wherein a rubber composition that is produced by coagulating E-SBR having specific glass transition temperature and a silica suspension, to which a conjugated diene rubber having different glass transition temperature in a specified range is blended, as well as its production method and compound. (Patent Document 8)

### PRIOR ART DOCUMENTS

### Patent Documents

[Patent Document 1] JP No. 2667420
[Patent Document 2] JP A 10-1565
[Patent Document 3] JP A 10-25368
[Patent Document 4] JP A 2004-99625
[Patent Document 5] JP A 2005-179436
[Patent Document 6] JP A 2003-238604
[Patent Document 7] JP No. 4583308
[Patent Document 8] JP No. 4583308

### Non-Patent Documents

[Non-Patent Document 1] G. Thielen, C. Berg: Kautsch. Gummi Kunstst., 07-08/2008, 377 (2008).

None of these technologies have reached even the beginning of industrialization, because they have many problems to be solved such as components to be blended and conditions of mixture and combination, etc.

The above-mentioned conventional technologies aim to improve the performance by highly dispersing silica; however, it is not easy to disaggregate the silica that has been once aggregated, and silica does not disperse while it is reacting with rubber polymers; therefore, performance improvement is not sufficient.

### SUMMARY OF THE INVENTION

### Problems to be Solved by the Invention

The present invention provides a rubber composition (silica master-batch) having highly dispersed silica, produced by mixing a dispersion solution of wet silica before its agglomerate or a suspension in which mechanically-disaggregated silica agglomerates have been highly dispersed in an aqueous solution, and a latex of emulsion-polymerized conjugated diene polymer comprising functional groups with high reactivity or affinity to silica; as well as a method for producing the same.

Furthermore, the present invention provides tires with superior properties such as reduced electric power during kneading, effect of reduction in rolling resistance, good abrasion resistance and wet grip performance.

### Means for Solving the Problems

The present invention relates to a rubber composition produced by mixing a latex of emulsion-polymerized conjugated diene copolymer, which is copolymerized with 0.02-10 wt % of monomers having at least one functional group selected from amino group, pyridyl group, alkoxysilyl group, epoxy group, carboxyl group, and hydroxyl group, and a silica suspension, wherein the mixing is performed such that the solid content of said silica suspension becomes 10-120 parts by weight relative to 100 parts by weight of the solid content of said latex of emulsion-polymerized conjugated diene copolymer, followed by adding an acid and/or a monovalent to trivalent metal salt, coagulating, then drying.

In addition, the present invention relates to a rubber composition produced by mixing a silica suspension, wherein the silica has a primary particle size of 1-200 nm and has not been subjected to a drying step of making the water content of the silica to be 30 wt % or less, and the mixing is performed such that the solid content of the silica becomes 10-120 parts by weight relative to 100 parts by weight of the solid content of the latex of conjugated diene copolymer, followed by coagulating and drying.

In addition, the present invention relates to a rubber composition produced by mixing a latex of conjugated diene copolymer and a silica suspension to which a compound having a carbon number of 6-50 and a reactivity to silanol groups on the silica surface has been previously added, wherein the mixing is performed such that the solid content of the silica becomes 10-120 parts by weight relative to 100 parts by weight of the solid content of the latex of conjugated diene copolymer, followed by coagulating and drying.

In addition, the present invention relates to a rubber composition, which is an emulsion-polymerized conjugated diene copolymer copolymerized with monomers having at least one functional group selected from alkoxysilyl group, epoxy group, and carboxyl group.

In addition, the present invention relates to a rubber composition of emulsion-polymerized conjugated diene copolymer copolymerized with monomers having at least one functional group selected from alkoxysilyl group, epoxy group, and carboxyl group, in an amount of 0.02-10 wt %.

In addition, the present invention relates to a rubber composition characterized in that 1-50 parts by weight of an extender oil is blended in the above-mentioned rubber composition.

In addition, the present invention relates to a rubber composition characterized in that 1-50 parts by weight of a carbon black is filled in the above-mentioned rubber composition.

In addition, the present invention relates to a method of producing a rubber composition, comprising mixing a silica suspension prepared under the alkaline condition of pH 7 or more and a latex of conjugated diene copolymer, and coagulation by heating, then drying.

In addition, the present invention relates to a method of producing a rubber composition, comprising mixing a silica suspension and a latex of conjugated diene copolymer, adding an acid and/or a monovalent to trivalent metal salt, coagulation by heating to 30-100° C., then drying.

In addition, the present invention relates to a method of producing a rubber composition, wherein in the drying step of the method, rubber crumb after coagulation (small lump of rubber) is dried with hot air, then processed through a hot roll with a temperature of at least 100° C. for drying in a sheet state.

In addition, the present invention relates to a rubber composition for tires, comprising the above-mentioned rubber composition in an amount of at least 30 wt %.

### Advantageous Effects of the Invention

In the present invention, a rubber composition that is highly reinforced by highly-dispersed silica, is obtained by mixing a suspension of highly-dispersed silica aggregate and a latex of emulsion-polymerized conjugated diene polymer copolymerized with monomers comprising functional groups with high reactivity or affinity to silanol groups present on the silica surface (monomers comprising amino group, pyridyl group, alkoxysilyl group, epoxy group, carboxyl group and hydroxyl group), followed by coagulating and drying.

The crumb comprising the silica is a material that is difficult to dry; therefore, drying by usual drying equipment for E-SBR, i.e., a combination of dehydrator and hot air dryer, is not sufficient. Accordingly, we have also developed a production process comprising a new drying process including the use of hot roll.

The rubber composition of the present invention has a high reinforcing characteristic, and stable quality upon vulcanization; when this rubber composition is used in tires, kneading is easy, and tires with reduced rolling resistance, excellent anti-abrasion characteristic and wet grip performance can be provided.

As the method of mixing a latex of emulsion-polymerized conjugated diene copolymer and a silica suspension, in addition to simple stirring and mixing, a step of coagulation with homogeneous mixing of these two systems by application of heat and pressure using a steam ejector is also desirable.

### BRIEF DESCRIPTION OF DRAWINGS

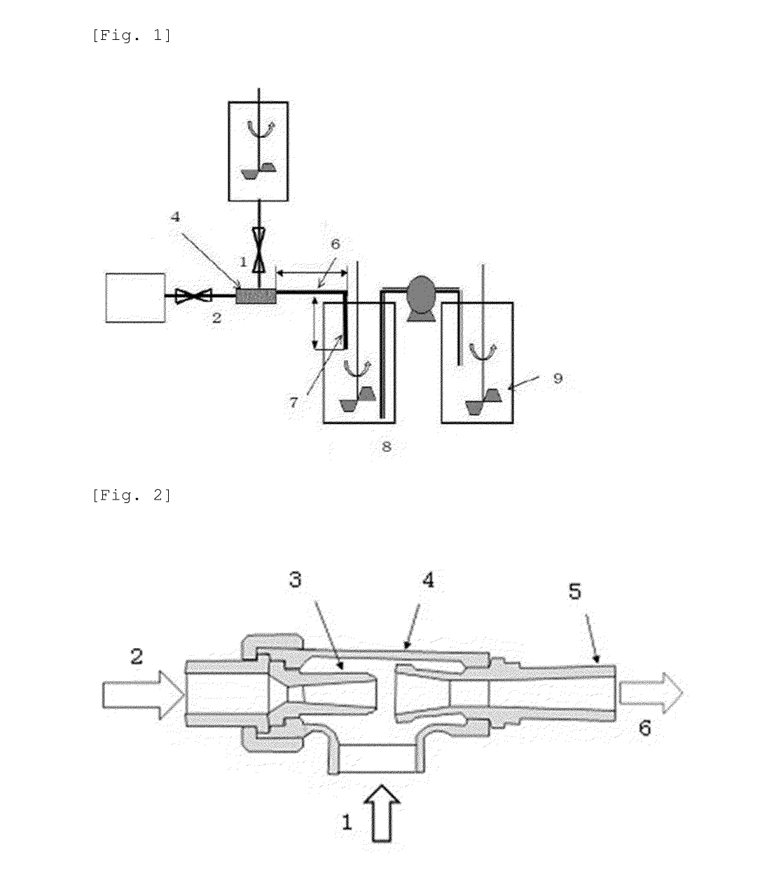

FIG. 1 shows an example of configuration of mixing step of a latex of emulsion-polymerized conjugated diene copolymer and a silica suspension, using a steam ejector.
“1” in FIG. 1 indicates inflow system of the mixture of a latex of emulsion-polymerized conjugated diene copolymer and a silica suspension.
“2” in FIG. 1 indicates inflow system of high pressure steam.
“4” in FIG. 1 indicates body of the steam ejector.
“6” in FIG. 1 indicates discharge system of the mixture of the latex of emulsion-polymerized conjugated diene copolymer and the silica suspension, processed by stimulation of temperature and pressure from the high pressure steam.
“7” in FIG. 1 indicates piping system of discharged product.
“8” in FIG. 1 indicates creaming tank.
“9” in FIG. 1 indicates coagulation tank, in which stirring is performed by addition of water and coagulant.

FIG. 2 shows an example of configuration of steam ejector.
“1” in FIG. 2 indicates inflow system of the mixture of a latex of emulsion-polymerized conjugated diene copolymer and a silica suspension.
“2” in FIG. 2 indicates inflow system of high pressure steam.
“3” in FIG. 2 indicates nozzle of the steam ejector.
“4” in FIG. 2 indicates main body of the steam ejector.
“5” in FIG. 2 indicates diffuser of the steam ejector.
“6” in FIG. 2 indicates discharge system of the mixture of the latex of emulsion-polymerized conjugated diene copolymer and the silica suspension, processed by stimulation of temperature and pressure from the steam.

### MODES FOR CARRYING OUT THE INVENTION

The following describes specific embodiments for carrying out the present invention.

Primary particles of silica bind each other to form solid aggregates. Upon drying, the aggregates further bind together to form agglomerates. Agglomerates can be fairly easily dispersed in water and can be returned to aggregates; however, in the dry state, the agglomerates are very difficult to be mixed and dispersed in rubbers, etc.

Therefore, in the present invention, a rubber composition that is highly reinforced by highly-dispersed silica is produced by mixing a suspension of highly-dispersed silica aggregate, and a latex of E-SBR copolymerized with monomers comprising functional groups with high reactivity or affinity to silanol groups present on the silica surface, and by coagulating and drying.

### <Monomers of Emulsion-Polymerized Conjugated Diene Polymer>

As monomers of emulsion-polymerized conjugated diene polymer, 1,3-butadiene and styrene are essential, and other monomers such as 2-methyl-1,3-butadiene, 2,3-dimethyl-1,3-butadiene, 1,3-pentadiene and α-methylstyrene, 2-methylstyrene, 3-methylstyrene, 4-methylstyrene, 2,4-diisopropyl styrene, etc. may also be used in combination.

The content of 1,3-butadiene in the emulsion-polymerized conjugated diene polymer is 50-95 wt %, preferably 60-90 wt %, and more preferably 65-80 wt %. Styrene content is 5-50 wt %, preferably 10-40 wt %, and more preferably 20-35 wt %.

The above-mentioned other monomers may be replaced with 1,3-butadiene and styrene in arbitrary proportions, provided that they are within 10 wt % of E-SBR.

Examples of polar groups in polar group-containing monomers are not particularly limited as long as they can react to the silica surface, and include, amino group, pyridyl group, alkoxysilyl group, epoxy group, carboxyl group, and hydroxyl group, etc. Of these, amino group, alkoxysilyl group, carboxyl group, and epoxy group are preferred, and alkoxysilyl group, carboxyl group, and epoxy group are more preferred.

Suitable content of polar group-containing monomer in E-SBR is 0.02-10 wt % of the total monomers in the E-SBR, preferably 0.05-5 wt %, more preferably 0.1-3 wt %.

Examples of primary amino group-containing monomers include p-aminostyrene, aminomethyl(meth)acrylate, aminoethyl(meth)acrylate, aminopropyl(meth)acrylate, and aminobutyl(meth)acrylate, etc.

Examples of secondary amino group-containing monomers include N-monosubstituted(meth)acrylamides, such as N-methyl(meth)acrylamide, N-ethyl(meth)acrylamide, N-methylolacrylamide, and N-(4-anilinophenyl)-methacrylamide.

Examples of tertiary amino group-containing monomers include N,N-disubstituted aminoalkyl(meth)acrylate, N,N-disubstituted aminoalkyl(meth)acrylamide, N,N-disubstituted aminoaromatic vinyl compound and a monomer having pyridyl group.

Examples of N,N-disubstituted amino(meth)acrylates include N,N-dimethylaminomethyl(meth)acrylate, N,N-dimethylaminoethyl(meth)acrylate, N,N-dimethylaminopropyl(meth)acrylate, N,N-dimethylaminobutyl(meth)acrylate, N,N-diethylaminoethyl(meth)acrylate, N,N-diethylaminopropyl(meth)acrylate, N,N-diethylaminobutyl(meth)acrylate, N-methyl-N-ethylaminoethyl(meth)acrylate, N,N-dipropylaminoethyl(meth)acrylate, N,N-dibutylaminoethyl(meth)acrylate, N,N-dibutylaminopropyl(meth)acrylate, N,N-dibutylaminobutyl(meth)acrylate, N,N-dihexylaminoethyl(meth)acrylate, N,N-dioctylaminoethyl(meth)acrylate, etc. Of these, N,N-dimethylaminoethyl(meth)acrylate, N,N-diethylaminoethyl(meth)acrylate, and N,N-dipropylaminoethyl(meth)acrylate are preferable.

Examples of N,N-disubstituted aminoaromatic vinyl compounds include N,N-dimethylaminoethyl styrene, N,N-diethylaminoethyl styrene, N,N-dipropylaminoethyl styrene, N,N-dioctylaminoethyl styrene, etc. Examples of monomers having pyridyl group include 2-vinylpyridine, 4-vinylpyridine, 5-methyl-2-vinylpyridine, 5-ethyl-2-vinylpyridine, etc. Of these, 2-vinylpyridine and 4-vinylpyridine are preferable.

These amino group-containing monomers may be used alone, or in combination of two or more kinds.

Alkoxysilyl group-containing monomers are monomers having at least one alkoxysilyl group in one molecule. Examples of alkoxysilyl group-containing monomers include (meth)acryloxymethyl trimethoxysilane, (meth)acryloxymethyl triethoxysilane, β-(meth)acryloxyethyl trimethoxysilane, β-(meth)acryloxyethyl triethoxysilane, γ-(meth)acryloxypropyl trimethoxysilane, γ-(meth)acryloxypropyl triethoxysilane, γ-(meth)acryloxypropyl tripropoxysilane, γ-(meth)acryloxypropyl tributoxysilane, γ-(meth)acryloxypropylmethyl dimethoxysilane, γ-(meth)acryloxypropylethyl dimethoxysilane, γ-(meth)acryloxypropylhexyl dimethoxysilane, β-acryloxyethyloxymethyl trimethoxysilane, γ-(β-acryloxyethyloxy)propyl trimethoxysilane, γ-(γ-methacryloxypropyloxy)propyl trimethoxysilane, vinyltri-n-butoxysilane, vinyltri-tert-butoxysilane, vinyltri-sec-butoxysilane, vinyltriisopropoxysilane, etc.

Of these, γ-(meth)acryloxypropyl triethoxysilane, γ-(meth)acryloxypropyl tripropoxysilane, γ-(meth)acryloxypropyl tributoxysilane, γ-(β-acryloxyethyloxy)propyl tributoxysilane, γ-(γ-methacryloxypropyloxy)propyl tributoxysilane, and vinyl alkoxysilanes are preferable, and γ-(meth)acryloxypropyl tripropoxysilane, γ-(meth)acryloxypropyl tributoxysilane, vinyltri-tert-butoxysilane are more preferable.

These alkoxysilyl group-containing monomers may be used alone, or in combination of two or more kinds.

Carboxyl group-containing monomers are monomers having at least one carboxyl group in one molecule. As the carboxyl group-containing monomers, methacrylic acid and acrylic acid are preferable. These carboxyl group-containing monomers may be used alone or in combination of two or more kinds.

Epoxy group-containing monomers are monomers having at least one epoxy group in one molecule. Examples of epoxy group-containing monomers include glycidyl(meth)acrylate, 3,4-epoxybutyl(meth)acrylate, 3,4-oxycyclohexyl(meth)acrylate, N-glycidyl(meth)acrylamide, vinyl glycidyl ether, allyl glycidyl ether, 2-methylallyl glycidyl ether, 3,4-epoxy-1-butene, 3,4-epoxy-1-methyl-1-butene, 3,4-epoxy-1-pentene, 3,4-epoxy-3-methyl-1-pentene, 5,6-epoxy-1-hexene, vinylcyclohexene monoxide, styrene-p-glycidyl ether, N-[4-(2,3-epoxy-1-oxo-3-phenylpropan-1-yl)phenyl]methacrylamide, etc. Of these, glycidyl(meth)acrylate is preferable. These epoxy group-containing monomers may be used alone or in combination of two or more kinds.

Hydroxyl group-containing monomers are monomers having at least one primary, secondary or tertiary hydroxyl group in one molecule. Specific examples of hydroxyl group-containing monomers include hydroxymethyl(meth)acrylate, 2-hydroxyethyl(meth)acrylate, 2-hydroxypropyl(meth)acrylate, 3-hydroxypropyl(meth)acrylate, 3-chloro-2-hydroxypropyl(meth)acrylate, 3-phenoxy-2-hydroxypropyl(meth)acrylate, glycerolmono(meth)acrylate, hydroxybutyl(meth)acrylate, 2-chloro-3-hydroxypropyl(meth)acrylate, hydroxyhexyl(meth)acrylate, hydroxyoctyl(meth)acrylate, hydroxymethyl(meth)acrylamide, 2-hydroxypropyl(meth)acrylamide, 3-hydroxypropyl(meth)acrylamide, di-(ethyleneglycol) itaconate, di-(propyleneglycol) itaconate, bis(2-hydroxypropyl) itaconate, bis(2-hydroxyethyl) itaconate, bis(2-hydroxyethyl) fumarate, bis(2-hydroxyethyl) maleate, 2-hydroxyethyl vinyl ether, hydroxymethyl vinyl ketone, allyl alcohol, etc. Of these, hydroxymethyl(meth)acrylate, 2-hydroxyethyl(meth)acrylate, 2-hydroxypropyl(meth)acrylate, 3-hydroxypropyl(meth)acrylate, 3-phenoxy-2-hydroxypropyl(meth)acrylate, glycerolmono(meth)acrylate, hydroxybutyl(meth)acrylate, hydroxyhexyl(meth)acrylate, hydroxyoctyl(meth)acrylate, 2-hydroxypropyl(meth)acrylamide, 3-hydroxypropyl(meth)acrylamide, etc. are preferable.

### <Polymerization Method>

Various polymerization methods can be applied as a polymerization method employed in the present invention; in terms of ease of removal of reaction heat during polymerization and productivity, emulsion polymerization method can be preferably employed.

As the emulsion polymerization method, usual emulsion polymerization method may be used; for example, predetermined amounts of the above-mentioned monomers are emulsion-dispersed in an aqueous medium in the presence of an emulsifier, and emulsion polymerization is carried out by a polymerization initiator. The amount of each monomer used is appropriately selected such that unit content of each monomer in the polymer has a desired value.

As emulsifiers, for example, long-chain fatty acid salt having a carbon number of 10 or more and/or rosin acid salt are used. Specific examples include a potassium salt or sodium salt of fatty acids such as capric acid, lauric acid, myristic acid, palmitic acid, oleic acid, and stearic acid. The amount of an emulsifier is, relative to the total monomer of 100 parts by weight, preferably 0.5-10 parts by weight, and more preferably 1-8 parts by weight.

Examples of polymerization initiator include persulfates such as ammonium persulfate and potassium persulfate; redox initiators such as a combination of ammonium persulfate and ferric sulfate, a combination of organic peroxide and ferric sulfate, and a combination of hydrogen peroxide and ferric sulfate, etc. The amount of a polymerization initiator is, relative to the total monomer of 100 parts by weight, preferably 0.01-5 parts by weight, and more preferably 0.05-3 parts by weight.

In order to adjust Mooney viscosity of polymers, a molecular weight modifier is used. Examples of molecular weight modifier include mercaptans such as t-dodecyl mercaptan, n-dodecyl mercaptan, and carbon tetrachloride, thioglycolic acid, diterpene, terpinolene, γ-terpinenes and the like. Of these, mercaptans are preferred, and t-dodecyl mercaptan is more preferred. The amount of molecular weight modifier is not particularly limited, and is, relative to the total monomer of 100 parts by weight, usually 0.01-5 parts by weight, preferably 0.02-1 part by weight, and more preferably 0.05-0.5 parts by weight.

Temperature of emulsion polymerization may be appropriately selected depending on the type of polymerization initiator to be used, and is typically 0-100° C., preferably 0-60° C. Any type of polymerization process may be applied, including continuous polymerization and batch polymerization, etc.

The polymerization conversion rate upon termination of polymerization reaction is, from the viewpoint of preventing gelation of polymers, preferably 85 wt % or less, and more preferably in the range of 50-80 wt %. Polymerization reaction is usually terminated by adding a polymerization terminator to the polymerization system at the time when a predetermined polymerization conversion rate is achieved. Examples of polymerization terminator include amine compounds such as diethylhydroxylamine and hydroxylamine; quinone compounds such as hydroquinone and benzoquinone; sodium nitrite, sodium dithiocarbamate and the like.

After termination of the polymerization reaction, an anti-aging agent (antioxidant) may be added as necessary. After termination of the polymerization reaction, unreacted monomers are removed from the resulting polymer latex. If desired, an extender oil in a state of emulsified dispersion may be blended in advance to the polymer latex, and mixed to produce an oil extended rubber.

In a coagulation method, using salts such as sodium chloride, potassium chloride, and calcium chloride as a coagulant, and while adjusting the pH value of the coagulation system to a predetermined value by addition of polymer flocculant or acids such as hydrochloric acid and sulfuric acid as necessary, a suspension wherein either wet silica before secondary aggregation or mechanically-disaggregated silica agglomerate is highly dispersed in water, is mixed with a latex of emulsion-polymerized conjugated diene polymer comprising functional groups having high reactivity or affinity to silica, and coagulated to form a crumb, which can be collected.

As a method of mixing a latex of emulsion-polymerized conjugated diene copolymer and a silica suspension, in addition to mixing with simple stirring, the following step is desirable: using a steam ejector shown in FIG. 1, both mixture systems are uniformly mixed and coagulated by application of stimuli such as heat and pressure. FIG. 1 shows an example of configuration of coagulation step by mixing a latex of emulsion-polymerized conjugated diene copolymer and a silica suspension, by application of stimuli such as heat and pressure using a steam ejector.

Due to strong flow from the ejection-inflow system of high pressure steam to the discharge system, a mixed solution of the mixed-solution inflow system is sucked, and discharged as a more homogeneous solution by shear force and thermal stimuli under high temperature. When the discharged product is coagulated, a rubber composition with a stable mixing quality wherein silica is uniformly dispersed in the rubber can be produced.

As shown in FIG. 1, when the mixed solution that has been discharged together with steam is stirred in the creaming tank, transferred to the coagulation tank, and stirred while adding water and a coagulant, a rubber composition with a more stable mixing quality can be produced owing to uniform mixing.

As a mixer to process high pressure steam and a mixed solution of a latex of emulsion-polymerized conjugated diene copolymer and a silica suspension, for example a steam ejector shown in FIG. 2 may be used.

The high pressure steam to be used here is 0.1-2 MPa, preferably 0.3-1.8 MPa, more preferably 0.5-1.5 MPa.

As a shape of the ejection port, it is preferable that the diameter of the pipe immediately after mixing (6 in FIG. 1) is smaller than the diameter of the outlet pipe (7 in FIG. 1).

After washing and dehydration, crumb may be dried by a hot air dryer and hot roll, etc. to provide conjugated diene rubber of interest.

However, silica easily adsorbs moisture, which frequently causes quality variation in the post process of vulcanization; therefore, drying only by normal dehydrator and hot air dryer is insufficient, and the use of hot roll with a temperature of 100° C. or more is preferable for sufficient drying.

### <Silica>

Examples of silica include dry silica, wet silica, colloidal silica, precipitated silica, etc. Of these, wet silica composed mainly of hydrous silicic acid is particularly preferred. These kinds of silica may be used alone or in combination of two or more.

Particle size of primary particles of silica is not particularly limited, and is 1-200 nm, more preferably 3-100 nm, and particularly preferably 5-60 nm. If the particle size of primary particles of silica is within this range, the silica shows excellent balance of tensile properties and low heat-generation property. Particle size of primary particles can be measured by an electron microscope or using specific surface area, etc.

As the highly dispersed silica suspension, undried wet silica may be used as is, or it may be produced by re-dispersing dried silica in water using a thin-film spin-type high speed stirrer, etc.

### <Silane Coupling Agent>

It is preferable to blend a silane coupling agent in the rubber composition of the present invention, in order to further improve tensile properties and low heat-generation property. The silane coupling agent may be added to a silica suspension, or it may be added during mixing of the rubber composition after drying and other agents for blending. Examples of silane coupling agent include vinyltriethoxysilane, β-(3,4-epoxycyclohexyl)ethyl trimethoxysilane, N-(β-aminoethyl)-γ-aminopropyl trimethoxysilane, tetrasulfides such as bis(3-triethoxysilylpropyl)tetrasulfide, bis(3-tri-iso-propoxysilylpropyl)tetrasulfide, bis(3-tributoxysilylpropyl)tetrasulfide, γ-trimethoxysilylpropyl dimethylthiocarbamyl tetrasulfide, γ-trimethoxysilylpropyl benzothiazyl tetrasulfide, and bis(3-triethoxysilylpropyl)disulfide, bis(3-tri-iso-propoxysilylpropyl)disulfide, bis(3-tributoxysilylpropyl)disulfide, γ-trimethoxysilylpropyl dimethylthiocarbamyl disulfide, γ-trimethoxysilylpropyl benzothiazyl disulfide, etc.

The silane coupling agent comprising 4 or less sulfurs in one molecule is preferable because scorch (thermal discoloration, scorching) during kneading can be avoided. The silane coupling agent comprising 2 or less sulfurs in one molecule is more preferable. These silane coupling agents may be used alone or in combination of two or more kinds.

The amount of a silane coupling agent blended relative to 100 parts by weight of silica is, preferably 0.1-30 parts by weight, more preferably 1-20 parts by weight, and particularly preferably 2-10 parts by weight.

The silane coupling agent may be added during kneading prior to vulcanization process. In addition, the silane coupling agent may also be added prior to coagulation during mixing step of a silica suspension and a latex of conjugated diene copolymer, and it may be added to the silica suspension, to the latex of conjugated diene copolymer, or to the mixed solution of the silica suspension and the latex of conjugated diene copolymer.

When a silane coupling agent is added prior to coagulation, those having bulky alkoxysilyl groups are preferable, and disulfide-based silane coupling agents are more preferred compared to tetrasulfide-based silane coupling agents, in terms of stability and reinforcing characteristic.

### <Extender Oil>

The rubber composition of the present invention may contain an extender oil in order to avoid too high viscosity upon blending of silica in a blended sample. Any extender oil conventionally used in the rubber industry may be used, including paraffinic extender oil, aromatic extender oil, and naphthenic extender oil.

The pour point of the extender oil is preferably from −20 to 50° C., more preferably from −10 to 30° C. Within this range, a rubber composition that is easily stretched and has an excellent balance of tensile properties and low heat-generation property can be obtained. Suitable aromatic carbon content of the extender oil (CA %, Kurtz analysis method) is preferably 20% or more, more preferably 25% or more, and suitable paraffinic carbon content of the extender oil (CP %) is preferably 55% or less, more preferably 45%. When CA % is too small, or CP % is too large, tensile properties may be insufficient. The content of polycyclic aromatic compounds in the extender oil is preferably less than 3%. This content is measured by IP346 method (an inspection method by The Institute Petroleum in England).

The content of the extender oil relative to 100 parts by weight of rubber composition is, preferably 1-50 parts by weight, more preferably 5-30 parts by weight. When the content of the extender oil is in this range, the viscosity of the rubber composition containing silica becomes appropriate, and the composition has an excellent balance of tensile properties and low heat-generation property.

### <Carbon Black>

As carbon black, for example, it is possible to use furnace black, acetylene black, thermal black, channel black, graphite and the like. Of these, furnace black is particularly preferred, and specific examples thereof include those with the following grades: SAF, ISAF, ISAF-HS, ISAF-LS, IISAF-HS, HAF, HAF-HS, HAF-LS, and FEF. These carbon blacks may be used alone or in combination of two or more kinds.

The specific surface area of carbon black is not particularly limited, and is, in terms of nitrogen adsorption specific surface area (N₂SA), preferably 5-200 m²/g, more preferably 50-150 m²/g, particularly preferably 80-130 m²/g. When the nitrogen adsorption specific surface area is within this range, rubber compositions have better tensile properties. Also, a DBP adsorption amount of carbon black is not particularly limited, and is preferably 5-300 ml/100 g, more preferably 50-200 ml/100 g, particularly preferably 80-160 ml/100 g. When the DBP adsorption amount is within this range, rubber compositions having better tensile properties can be obtained. Furthermore, abrasion resistance of rubber compositions can be improved by using, as the carbon black, high-structured carbon black disclosed in JP A No. 5-230290, wherein the cetyltrimethylammonium bromide-adsorption (CTAB) specific surface area is 110-170 m²/g, and the DBP oil absorption after application of the pressure of 24,000 psi for four times (24M4DBP) is 110-130 ml/100 g.

The amount of carbon black filled per 100 parts by weight of a rubber component is 1-50 parts by weight, preferably 2-30 parts by weight, particularly preferably 3-20 parts by weight.

When the rubber composition of the present invention is used as a rubber composition for tires, it may comprise a rubber other than the rubber composition comprising emulsion-polymerized conjugated diene polymer and silica, within a range that does not essentially impair the effects of the present invention. Examples of other rubber include natural rubber, isoprene rubber, butadiene rubber, acrylonitrile-butadiene copolymer rubber, butyl rubber, ethylene-propylene-diene rubber, etc.

When the rubber composition of the present invention is used, the rubber composition may comprise, as necessary, and within a range that does not impair the scope of the present invention, various chemicals generally used in the rubber industry, such as vulcanizing agent, vulcanization accelerator, process oil, antioxidant, scorch inhibitor, zinc white, and stearic acid, etc. The rubber composition of the present invention can be kneaded by using a kneading machine such as roll and internal mixer. After molding, vulcanization is carried out, and the composition can be used not only for tires such as tire tread, under tread, carcass, sidewall, bead portions, etc., but also for other industrial applications including vibration isolation rubber, belt and hose; in particular it can be preferably used in a rubber for tire tread.

Pneumatic tires of the present invention are produced by a usual method using the rubber composition of the present invention. That is, as necessary, the rubber composition of the present invention containing various chemicals as described above is extruded into a tread compound prior to the vulcanization stage, pasting-molded by usual method in a tire molding machine, to give a crude tire. This crude tire is heated and pressurized in a vulcanizing machine to give final tire. Thus-obtained pneumatic tire of the present invention shows excellent low fuel consumption, fracture characteristics and abrasion resistance; in addition, because processability of the rubber composition is good, excellent productivity can be achieved.

### EXAMPLES

The present invention is to be described in more detail with reference to examples; however, the present invention is not limited to these examples in any way. Here, physical properties of polymers were measured in accordance with the following methods.

### <Physical Properties of Polymers>

Weight-average molecular weight (Mw) of polymers was measured by gel permeation chromatography “GPC; HLC-8020 from Tosoh Corporation, column; GMHXL from Tosoh Corporation (2 in series),” using a differential refractive index (R1), and polystyrene conversion with monodispersed polystyrene as a standard. Styrene unit content in polymers was calculated from the integral ratio of ¹H-NMR spectrum. Glass transition temperature (T_{g}) of polymers was measured using a differential scanning calorimetry (DSC) type 7 apparatus from Perkin Elmer Co., Ltd., under the condition that the temperature was cooled to −100° C., then raised at 10° C./min.

Kneading properties, as well as physical properties of vulcanized rubber were measured by the method described below, and the Mooney viscosity of rubber composition was measured in the following manner.

### <Kneading Method>

Kneading to produce vulcanized rubber composition is carried out in accordance with JIS K 6299: 2001 “Rubber test mixes—Preparation, mixing and vulcanization—Equipment and procedures”.

Kneading conditions of the rubber composition that does not contain a vulcanizing agent (A kneading) are: using a Banbury mixer Labo Plastomill manufactured by Toyo Seiki Seisaku-sho, Ltd., a filling rate of approximately 65% (by volume), rotation speed of rotor of 50 rpm, and kneading start temperature of 90° C.

Kneading properties are determined at the highest value of kneading torque (Nm) during blending of A kneading, and smaller values indicate easy kneading.

In the kneading condition of blending a vulcanizing agent in the rubber composition after A kneading (i.e., B kneading), the vulcanizing agent was blended at room temperature using a 8-inch roll from Daihan Co., Ltd.

### <Physical Properties of Vulcanized Rubber>

### (1) Low Heat-Generation Property

Temperature variance in viscoelasticity test was measured using a “viscoelastic measurement device RSA3 from TA INSTRUMENTS”, in accordance with JIS K 7244-7: 2007 “Plastics—Determination of dynamic mechanical properties—Part 7: Torsional vibration—Non-resonance method,” with a measurement frequency of 10 Hz, measurement temperature from −50 to 80° C., dynamic strain of 0.1%, a temperature raising rate of 4° C./min, and a sample with a shape of “width 5 mm×length 40 mm×thickness 1 mm.” The smaller value of tan δ (60° C.) indicates lower heat-generation property.

### (2) Fracture Characteristics

Tensile strength at breaking (T_{B}) was measured in accordance with JIS K 6251: 2004.

### (3) Abrasion Resistance

The amount of abrasion of vulcanized rubber compositions was measured in accordance with JIS K 6264-2: 2005 “Rubber, vulcanized or thermoplastic—Determination of abrasion resistance—Part 7: Testing methods,” Akron abrasion test, Method B. Results are expressed as abrasion resistance index, with the abrasion resistance of the control sample set at 100. Larger indices indicate better properties.

### <Mooney Viscosity of Rubber Compound>

Mooney viscosity [ML_{1+4/100° C.}] was measured in accordance with JIS K 6300-2001 at 100° C.

### Production Example 1

Using a 100-L polymerization reactor, predetermined amounts of water, an emulsifier, styrene, and butadiene were charged in accordance with the polymerization recipe shown in Table 1 without using functional group-containing monomers. Thereafter, the temperature of the polymerization reactor was set at 5° C., and polymerization was initiated by adding an initiator, a molecular weight moderator and an electrolyte shown in Table 1 as radical polymerization initiator. When the polymerization conversion rate reached 60% after about 6 h, polymerization was terminated by addition of diethylhydroxylamine. Then, unreacted monomers were collected by steam stripping and a latex of the conjugated diene polymer was obtained. A portion of this latex was removed for analysis, coagulated with sulfuric acid and sodium chloride to form crumb. Then, this crumb was dried by a hot air dryer. Analytical values of the obtained copolymer are summarized in Table 2. The latex of the emulsion polymerized polymer obtained is indicated as “N-SB-L1,” and the coagulated emulsion copolymer as “N-SB-R1.”

Table 1 shows standard polymerization recipe of conjugated diene polymers.

TABLE 1
Standard Polymerization Recipe

| Agent | Unit in Weight Parts |
|---|---|
| Monomer | |
| Butadiene | 75-3a/4 |
| Styrene | 25-a/4 |
| Functional group-containing monomer (a) | a |
| Medium | |
| Water | 200 |
| Emulsifier | |
| Disproportionated sodium rosinate | 4.5 |
| Sodium alkylaryl sulfonate | 0.5 |
| Initiator | |
| p-menthane hydroperoxide | 0.10 |
| Iron (II) sulfate (FeSO₄•7H₂O) | 0.05 |
| Sodium formaldehydesulfmrylate | 0.15 |
| Sodium edetate dehydrate | 0.80 |
| Molecular weight moderator | |
| tert-Dodecylmercaptan | 0.20 |
| Electrolyte | |
| Trisodium phosphate | 0.50 |

### Production Example 2

In accordance with Production Example 1, 3 parts by weight of methacrylic acid were added, and after properly adjusting the emulsion polymerization conditions, emulsion polymerization was performed similarly. The obtained emulsion copolymer was analyzed in a similar manner, and analytical values were also summarized in Table 2. The latex of the obtained emulsion polymerized polymer was indicated as “M-SB-L1.”

### Production Example 3

In accordance with Production Example 1, 6 parts by weight of γ-glycidyl methacrylate were added, and emulsion polymerization was performed similarly. Analytical values of the obtained emulsion copolymer were also summarized in Table 2. The latex of the obtained emulsion polymerized polymer was indicated as “M-SB-L2.”

### Production Example 4

In accordance with Production Example 3, 3 parts by weight of γ-glycidyl methacrylate were added, and emulsion polymerization was performed similarly. Analytical values of the obtained emulsion copolymer were also summarized in Table 2. The latex of the obtained emulsion polymerized polymer was indicated as “M-SB-L3.”

### Production Example 5

In accordance with Production Example 3, 1 part by weight of γ-glycidyl methacrylate was added, and emulsion polymerization was performed similarly. Analytical values of the obtained emulsion copolymer were also summarized in Table 2. The latex of the obtained emulsion polymerized polymer was indicated as “M-SB-L4.”

### Production Example 6

In accordance with Production Example 3, 1 part by weight of N, N-dimethylaminoethyl(meth)acrylate was added, and emulsion polymerization was performed similarly. Analytical values of the obtained emulsion copolymer were also summarized in Table 2. The latex of the obtained emulsion polymerized polymer was indicated as “M-SB-L5.”

### Production Example 7

In accordance with Production Example 3, 1 part by weight of vinyltri-tert-butoxysilane was added, and emulsion polymerization was performed similarly. Analytical values of the obtained emulsion copolymer were also summarized in Table 2. The latex of the obtained emulsion polymerized polymer was indicated as “M-SB-L6.”

Table 2 shows analytical results of the obtained emulsion copolymers.

TABLE 2
Analytical data of emulsion copolymer

| | | Production | Production | Production | Production | Production | Production | Production |
|---|---|---|---|---|---|---|---|---|
| | Unit | Eample-1 | Eample-2 | Eample-3 | Eample-4 | Eample-5 | Eample-6 | Eample-7 |
| Styrene (additive amount) | Weight % | 25 | 24.2 | 23.5 | 24.2 | 24.7 | 24.7 | 24.7 |
| Butadiene (additive amount) | Weight % | 75 | 72.8 | 70.5 | 72.8 | 73.8 | 74.3 | 74.3 |
| Functional group contained | Weight % | 0 | 3 | 6 | 3 | 1.5 | 1 | 1 |
| monomer (additive amount) | | | | | | | | |

| | | | | | |
|---|---|---|---|---|---|
| Kind | — | methacrylic | γ-glycidyl methacrylate | N,N-dimethyl | vinyltri-tert- |
| | | acid | | aminoethyl | butoxysilane |
| | | | | (meth)acrylate | |

Analytical data of emulsion copolymer after coagulation

| | | | | | | | | |
|---|---|---|---|---|---|---|---|---|
| Styrene Content | % | 23 | 23 | 22 | 23 | 23 | 22 | 23 |
| Content of Functional group- | % | 0 | 1.2 | 4.5 | 2.4 | 0.8 | 0.5 | 0.6 |
| containing monomer | | | | | | | | |

### Example 1

A rubber composition was produced by coagulating “M-SB-L1” produced in Production Example 2 and silica, under the following conditions.

As the silica, a silica cake with a silica content of 20% was obtained from a silica manufacturing company, which was a mixture of water and the silica prior to drying having the following properties: when measured after general drying process, BET surface area of 175 m²/g, a DBP oil absorption amount of 220 ml/100 g, and average particle size of secondary particles of 120 μm. The average particle size of primary particles of this silica was 20 nm. This silica cake is indicated as “WS-1.”

To a latex of the functional group-containing emulsion copolymer “M-SB-L1” in an amount equivalent to solids 1000 g, the silica cake “WS-1” in an amount equivalent to solids 550 g was added portionwise under stirring, to obtain a uniform suspension of the emulsion copolymer and the silica. A latex of styrene phenol as antioxidant was added thereto in an amount one part per SBR. Then, 900 ml of 10% aqueous sodium chloride solution and 1% polyethylene glycol solution and 5% sulfuric acid were added to adjust the pH to be 4. A silica-rubber composition was deposited in a crumb-like state having a size of around 1 cm. This product was filtered through a 40-mesh stainless steel wire mesh, washed with water to obtain the silica-rubber composition. This composition was placed in a hot air dryer at 100° C. and dried. Considering the loss of the rubber composition during operation, almost all amounts were recovered. The silica content of this rubber composition was determined by combustion, to be 54 phr.

### Examples 2-6

Similarly to Example 1, a rubber composition was produced by coagulation of “M-SB-L2 to M-SB-L6” produced in Production Examples 3-7 and the silica “WS-1.” Using these compositions and compounding recipe of Table 3, physical properties of vulcanizates were evaluated and summarized in Table 4.

### Comparative Example 1

Similarly to Example 1, a rubber composition was produced by coagulation of “N-SB-L1” produced in Production Example 1 and the silica “WS-1.” Physical properties of this vulcanized compound were evaluated and summarized in Table 4.

### Comparative Examples 2-4

In Comparative Example 2, “N—SB-R1” that was made by coagulation of “N-SB-L1” without silica, and a hot air-dried rubber composition were used, and physical properties of vulcanizates were evaluated similarly to Example 1 and summarized in Table 4. In Comparative Example 3, the emulsion polymerized SBR #1502 from JSR (Co., Ltd.) was used with silica blending, and in Comparative Example 4, the same SBR #1502 and carbon black instead of silica were used; physical properties of vulcanizates were evaluated and summarized in Table 4.

Table 3 shows compounding recipe of rubber compositions consisting of emulsion polymerized polymers and silica. Here, English abbreviations of compounding ingredient names, etc. used in Table 3 are well known to those skilled in the art, but their meanings are indicated below for confirmation.

Silane coupling agent “Si69”: bis(3-triethoxysilylpropyl)tetrasulfide,
Polyethylene glycol “PEG4000”: polyethylene glycol 4000, Antioxidant “6C”:
N-phenyl-N′-(1,3-dimethylbutyl)-p-phenyldiamine,
Vulcanization accelerator “D”: N,N′-diphenyl guanidine,
Vulcanization accelerator “CZ”: N-cyclohexyl-2-benzothiazolyl sulfenamide.

TABLE 3
Compounding Recipe

| Compounding Recipe | Grade | phr |
|---|---|---|
| Rubber | | 100 |
| Silica | | 55 |
| Silane coupling agent | Si69 | 6 |
| Polyethylene glycol | PEG4000 | 4 |
| Carbon black | N339 | 4 |
| Aromatic oil | | 10 |
| Zinc oxide | | 3 |
| Stearic acid | | 2 |
| Antioxidant | 6C | 1 |
| Vulcanization accelerator | D | 0.5 |
| Vulcanization accelerator | CZ | 2.5 |
| Sulfur | | 1.5 |

| | |
|---|---|
| Total | 189.5 |

Table 4 shows evaluation results of physical properties of the vulcanized rubber compositions made from emulsion polymerized polymers and silica.

TABLE 4
Physical properties of vulcanizate

| | | | | | | | Comparative | Comparative | Comparative | Comparative |
|---|---|---|---|---|---|---|---|---|---|---|
| | Example-1 | Example-2 | Example-3 | Example-4 | Example-5 | Example-6 | Example-1 | Example-2 | Example-3 | Example-4 |
| Latex of emulsion | M-SB-L1 | M-SB-L2 | M-SB-L3 | M-SB-L4 | M-SB-L5 | M-SB-L6 | N-SB-L1 | N-SB-R1 | Commercial E-SBR | |
| polymerized | | | | | | | | | | |
| polymer or | | | | | | | | | | |
| Solid rubber | | | | | | | | | | |
| Filler | WS-1 | WS-1 | WS-1 | WS-1 | WS-1 | WS-1 | WS-1 | Commercial Dry Silica of | | Carbon black |
| | | | | | | | | WS-1 | | |
| Blending Method | Wet blended | | | | | | | Dry blended | | |
| Maximum value of | 240 | 350 | 330 | 345 | 320 | 340 | 285 | 480 | 505 | 375 |
| average torque | | | | | | | | | | |
| during kneading | | | | | | | | | | |
| (Nm) | | | | | | | | | | |
| Tensile Strength | 22.4 | 28.8 | 29.7 | 28.8 | 22.5 | 30.5 | 23.7 | 22.0 | 21.1 | 26.0 |
| (MPa) | | | | | | | | | | |
| Modulus 100%, | 5.3 | 4.5 | 4.1 | 4.0 | 3.8 | 4.3 | 3.5 | 3.4 | 3.3 | 3.5 |
| M₁₀₀ (MPa) | | | | | | | | | | |
| Modulus 300%, | 16.7 | 18.8 | 22.8 | 21.9 | 15.2 | 23.0 | 14.8 | 15.1 | 14.6 | 17.9 |
| M₃₀₀ (MPa) | | | | | | | | | | |
| Elongation at | 370 | 280 | 370 | 380 | 410 | 430 | 430 | 400 | 390 | 430 |
| breaking (%) | | | | | | | | | | |
| Akron abrasion | 122 | 130 | 150 | 140 | 115 | 135 | 90 | 70 | 71 | 100 |
| resistance | | | | | | | | | | |
| (Index) | | | | | | | | | | |
| Dynamic | | | | | | | | | | |
| viscoelasticity | | | | | | | | | | |
| test | | | | | | | | | | |
| tanδ (0° C.) (Index) | 158 | 116 | 129 | 111 | 116 | 134 | 90 | 83 | 86 | 100 |
| tanδ (60° C.) | 126 | 118 | 135 | 143 | 122 | 128 | 126 | 142 | 142 | 100 |
| (Index) | | | | | | | | | | |

Results shown in Table 4 indicate that the rubber compositions made by coagulation of the latex of emulsion-polymerized conjugated diene copolymers and the silica suspension have a low maximum value of average torque during kneading, showing good kneading properties.

In Examples 1-6, the modulus (M1₀₀, M₃₀₀) are high, which is considered to indicate that interaction between the functional group-containing emulsion polymerized copolymer and the silica is high. Accordingly, the Akron abrasion resistance showed a good value equal to or higher than that of the rubber composition comprising commercially available E-SBR and carbon black. tan δ (60° C.) that serves as an index of low fuel consumption is also remarkably superior to that of the rubber composition with carbon black filled.

These results show physical properties of vulcanizates, demonstrating good processability during kneading, durability, low fuel consumption, and good balance between wet grip performance and abrasion resistance.

### Example 7

In a similar recipe as in Example 1, a rubber composition was produced similarly to Example 1, except that a silane coupling agent, i.e., bis(3-tributoxysilylpropyl)disulfide was added at 2 phr per silica solid content, upon coagulation of “M-SB-L4” and the silica “WS-1.” Physical properties of vulcanizates were evaluated similarly to Example 1 and summarized in Table 5.

### Example 8

The rubber composition of Example 7 was further dried using a hot roll at 120° C. for 10 min, to produce the rubber composition of Example 8. Physical properties of this vulcanized rubber composition were evaluated and summarized in Table 5.

### Example 9

In a similar recipe as in Example 1, a rubber composition was produced using “M-SB-L4” and the silica “WS-1” by coagulation, hot-air drying then further drying by a hot roll. Physical properties of this vulcanized rubber composition were evaluated and summarized in Table 5.

### Example 10

Dried silica obtained after drying step of the silica cake used in Example 1 was added to distilled water at a content of 20%, and a suspension of this silica was prepared using T. K. Hivis Disper Mix from PRIMIX Corporation. This silica suspension is referred to as “WS-2.” Then, in a similar recipe as in Example 1 and using “M-SB-L4” and the silica “WS-2,” a rubber composition was produced by coagulation and hot air drying. Physical properties of this vulcanized rubber composition were evaluated and summarized in Table 5.

TABLE 5
Physical properties of vulcanizate

| | Example-7 | Example-8 | Example-9 | Example-10 |
|---|---|---|---|---|
| Latex of emulsion polymerized polymer | M-SB-L4 | | | |
| Filler | WS-1 | | | WS-2 |
| Blending Method | Wet blended | | | |
| Silane coupling agent | Si*¹⁾ | | — | — |
| Drying Method | Hot air drying | Hot air drying and | | Hot air drying |
| | | Hot roll drying | | |
| Maximum value of average torque during | 340 | 330 | 300 | 365 |
| kneading (Nm) | | | | |
| Tensile Strength (MPa) | 29.8 | 30.5 | 30.1 | 27.1 |
| Modulus 100%, M₁₀₀ (MPa) | 5.3 | 5.5 | 5.1 | 3.5 |
| Modulus 300%, M₃₀₀ (MPa) | 23.4 | 23.8 | 19.8 | 18.5 |
| Elongation at breaking (%) | 430 | 380 | 370 | 370 |
| Akron abrasion resistance (Index) | 145 | 170 | 152 | 125 |
| Dynamic viscoelasticity test | | | | |
| tanδ(0° C.) (Index) | 133 | 130 | 121 | 110 |
| tanδ(60° C.) (Index) | 156 | 165 | 148 | 136 |

*¹⁾bis(3-tributoxysilylpropyl) disulfide
*²⁾Larger index values indicate better properties.

Results shown in Table 5 indicate that better physical properties of vulcanizates are obtained under the condition that polymer and silica are easily reacted. In addition, silica agglomerates are considered to be disaggregated to some extent.

### Example 11

A rubber composition was produced similarly to Example 1 by coagulation, except that the latex of emulsion polymerized polymer “M-SB-L1” and the silica suspension “WS-1” were pre-mixed, and that the mixed solution was mixed using steam ejector.

When the latex of emulsion-polymerized conjugated diene copolymer and the silica suspension were mixed using steam ejector, the mixture of the both substances was subjected to the reaction such as stimulation by temperature and pressure from high pressure steam, and the emulsified particles of the emulsion-polymerized conjugated diene copolymer and the particles of the silica suspension were mixed more homogeneously.

The resulting coagulation product was hot-air dried and further dried by hot roll to prepare a rubber composition. The silica content was approximately 55 phr. Physical properties of this vulcanized rubber composition were evaluated and summarized in Table 6.

### Examples 12-14

In a similar recipe as in Example 11, a mixed solution of the latex of emulsion polymerized polymer“M-SB-L4” and the silica suspension “WS-1” was homogenized and coagulated using a steam ejector with varying the pressure of the high pressure steam at 0.3 MPa, 0.6 MPa, and 0.9 MPa as shown in the table. While the silica content was mostly 55 phr, the turbidity of the cleaning liquid of the rubber composition tended to increase as the pressure of the steam decreases.

This coagulation product was hot-air dried, then further dried by hot roll, to produce a rubber composition. Physical properties of this vulcanized rubber composition were evaluated and summarized in Table 6.

TABLE 6
Physical properties of vulcanizate

| | Example-11 | Example-12 | Example-13 | Example-14 |
|---|---|---|---|---|
| Latex of emulsion polymerized polymer | M-SB-L1 | M-SB-L4 | | |
| Filler | WS-1 | | | |
| Blending Method | Wet blended | | | |
| Steam ejector | Using | | | |
| Pressure of high-pressure steam (MPa) | 0.9 | 0.3 | 0.6 | 1.1 |
| Drying Method | Hot air drying and Hot roll drying | | | |
| Maximum value of average torque during | 250 | 330 | 310 | 280 |
| kneading (Nm) | | | | |
| Tensile Strength (MPa) | 23.5 | 29.8 | 31.8 | 32.5 |
| Modulus 100%, M₁₀₀ (MPa) | 6.1 | 5.3 | 5.3 | 5.8 |
| Modulus 300%, M₃₀₀ (MPa) | 18.8 | 21.5 | 22.6 | 22.8 |
| Elongation at breaking (%) | 410 | 400 | 410 | 420 |
| Akron abrasion resistance (Index) | 136 | 165 | 175 | 182 |
| Dynamic viscoelasticity test | | | | |
| tanδ(0° C.) (Index) | 160 | 133 | 133 | 140 |
| tanδ(60° C.) (Index) | 134 | 156 | 165 | 171 |

*¹⁾Larger index values indicate better properties.

Results shown in Table 6 are considered to indicate that, when the shear force is large under high temperature and strong blowout, then homogenization of the latex of emulsion polymerized polymer and silica suspension is promoted and physical properties of vulcanizates are improved.

1. A rubber composition produced by mixing a latex of emulsion-polymerized conjugated diene copolymer, which is copolymerized with 0.02-10 wt % of monomers having at least one functional group selected from amino group, pyridyl group, alkoxysilyl group, epoxy group, carboxyl group, and hydroxyl group, and a silica suspension, wherein the mixing is performed such that the solid content of said silica suspension becomes 10-120 parts by weight relative to 100 parts by weight of the solid content of said latex of emulsion-polymerized conjugated diene copolymer, followed by adding an acid and/or a monovalent to trivalent metal salt, coagulating, then drying.

2. The rubber composition according to claim 1, produced by mixing a silica suspension, wherein the silica has a primary particle size of 1-200 nm and has not been subjected to a drying step of making the water content of the silica to be 30 wt % or less, and the mixing is performed such that the solid content of the silica becomes 10-120 parts by weight relative to 100 parts by weight of the solid content of the latex of conjugated diene copolymer, followed by coagulating and drying.

3. The rubber composition according to claim 1, produced by mixing the silica suspension and the latex of conjugated diene copolymer using a steam ejector, followed by coagulating and drying.

4. The rubber composition according to claim 1, produced by mixing the latex of conjugated diene copolymer and the silica suspension to which a compound having a carbon number of 6-50 and a reactivity to silanol groups on the silica surface has been previously added, wherein the mixing is performed such that the solid content of the silica becomes 10-120 parts by weight relative to 100 parts by weight of the solid content of the latex of conjugated diene copolymer, followed by coagulating and drying.

5. The rubber composition according to claim 1, wherein the emulsion-polymerized conjugated diene copolymer is an emulsion-polymerized conjugated diene copolymer copolymerized with monomers having at least one functional group selected from alkoxysilyl group, epoxy group, and carboxyl group.

6. The rubber composition according to claim 1, wherein the emulsion-polymerized conjugated diene copolymer is an emulsion-polymerized conjugated diene copolymer copolymerized with monomers having at least one functional group selected from alkoxysilyl group, epoxy group, and carboxyl group, in an amount of 0.02-10 wt %.

7. A rubber composition characterized in that 1-50 parts by weight of an extender oil is blended in the rubber composition according to claim 1.

8. A rubber composition characterized in that 1-50 parts by weight of a carbon black is filled in the rubber composition according to claim 1.

9. A method of producing a rubber composition, comprising the steps of:
mixing a latex of emulsion-polymerized conjugated diene copolymer, which is copolymerized with monomers having at least one functional group selected from amino group, pyridyl group, alkoxysilyl group, epoxy group, carboxyl group, and hydroxyl group, and a silica suspension;
adding an acid and/or a monovalent to trivalent metal salt;
coagulating; and
drying.

10. The method of producing a rubber composition according to claim 9, wherein the coagulating is carried out with heating to 30-100° C., then drying.

11. The method of producing a rubber composition according to claim 9, wherein in the mixing step, the silica suspension and the latex of conjugated diene copolymer are mixed using a steam ejector.

12. The method of producing a rubber composition according to claim 9, wherein in the drying step, rubber crumb after coagulation (small lump of rubber) is dried with hot air, then processed through a hot press roller with a temperature of at least 100° C. for drying in a sheet state.

13. A rubber composition for tires, comprising the rubber composition according to claim 1 in an amount of at least 30 wt %.
